(19) United States
(12) Patent Application Publication
(10) Pub. No.: US 2014/0372779 A1
(43) Pub. Date: Dec. 18, 2014

(54) CONTROL SYSTEM AND METHOD FOR POWER SHUTDOWN OF ELECTRONIC DEVICE

(71) Applicants: Hon Hai Precision Industry Co., Ltd., New Taipei (TW); Fu Tai Hua Industry (Shenzhen) Co., Ltd., Shenzhen (CN)

(72) Inventors: SHIH-FANG WONG, New Taipei (TW); XIN LU, Shenzhen (CN); YU-CUI ZHOU, Shenzhen (CN)

(73) Assignees: HON HAI PRECISION INDUSTRY CO., LTD., New Taipei (TW); FU TAI HUA INDUSTRY (SHENZHEN) CO., LTD., Shenzhen (CN)

(21) Appl. No.: 14/017,315

(22) Filed: Sep. 4, 2013

(30) Foreign Application Priority Data
Jun. 14, 2013 (CN) 2013102354985

(51) Int. Cl. G06F 1/32; H04N 7/18; G06F 3/16

(52) U.S. Cl. CPC G06F 1/3231; G06F 3/16; H04N 7/183
USPC 713/323

(57) ABSTRACT

A control system for power shutdown of an electronic device is provided. The electronic device includes a sound monitor. The sound monitor monitors a decibel level of sound generated by surrounding environment. The control system includes a sound acquiring module, a first determining module, and a control module. The sound acquiring module acquires the decibel level of the sound from the sound monitor. The first determining module determines whether or not the acquired decibel level of the sound is within a predetermined range. The control module controls the electronic device to enter a shutdown state when the acquired decibel level of the sound is within the predetermined range. An electronic device and a method for power shutdown are also provided.

### BACKGROUND

1. Technical Field

The present disclosure relates to control systems, and particularly to a control system and a method for power shutdown of an electronic device.

2. Description of Related Art

When user is busy or in a hurry, it is easy to forget turning off electronic devices, such as a computer, resulting in waste of energy and possible damage for the electronic devices.

Therefore, what is needed is a control system for power shutdown to overcome the above described limitations.

### BRIEF DESCRIPTION OF THE DRAWING

FIG. 1 is a block diagram of a control system for power shutdown of an electronic device in accordance with an exemplary embodiment.

FIG. 2 is a flowchart of a power shutdown method implemented by the control system of FIG. 1.

### DETAILED DESCRIPTION

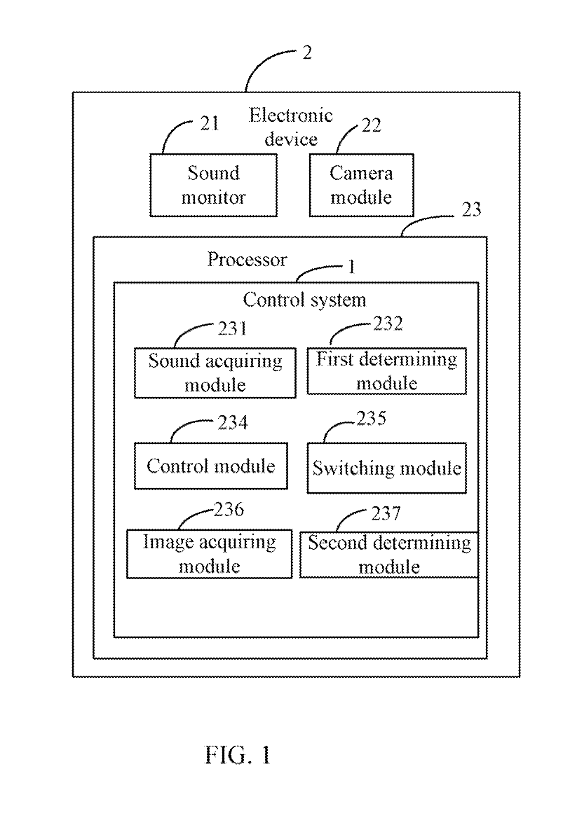

FIG. 1 shows a control system 1 for power shutdown of an electronic device 2. The control system 1 runs in the electronic device 2. The electronic device 2 includes a sound monitor 21, a camera module 22, and a processor 23. The sound monitor 21 monitors a decibel level of sound generated by surrounding environment when in an enabled state. The camera module 22 captures an image of surrounding environment when in an enabled state. For example, the camera module 22 can capture an image of an object in front of the electronic device 2, or an image of an object in back of the electronic device 2, or captures images of the objects which surround the electronic device 2. In one embodiment, the electronic device 2 may be panel computer, desktop computer, or digital frame, for example.

The processor 23 includes a sound acquiring module 231, a first determining module 232, and a control module 234 which are collection of software instructions executed by the processor 23.

The sound acquiring module 231 acquires the decibel level of the sound from the sound monitor 21. The first determining module 232 determines whether or not the acquired decibel level of the sound is within a predetermined range. For example, the acquired decibel level is 2 dB, and the predetermined range is from 1 dB to 6 dB, the acquired decibel level is within the predetermined range. The control module 234 controls the electronic device 2 to enter a shutdown state when the acquired decibel level of the sound is within the predetermined range.

The processor 23 further includes a switching module 235 which is collection of software instructions. The switching module 235 turns on/down the sound monitor 21 and the camera module 22 to switch the sound monitor 21 and the camera module 22 between an enabled state and a disabled state in response to a user operation. Therefore, when a user does not need the electronic device 2 to be automatically shut down by the control system 1, the user can manually turn down the sound monitor 21. In one embodiment, the switching module 235 may be a switch or a key, for example.

The processor 23 further includes an image acquiring module 236 and a second determining module 237. The switching module 235 further turns on the camera module 22 to acquire the image of the surrounding environment when the acquired decibel level of the sound is within the predetermined range. The image acquiring module 236 acquires the image of surrounding environment from the camera module 22. The second determining module 237 determines whether or not the acquired image matches a predetermined image. In one embodiment, the second determining module 237 determines whether or not each pixel value of the acquired image is equal to each pixel value of the predetermined image to determine whether or not the acquired image matches the predetermined image. The control module 234 controls the electronic device 2 to enter the shutdown state when the acquired image matches the predetermined image. In other embodiment, the second determining module 237 further determines whether or not a number of acquired images match a number of predetermined images. The control module 234 controls the electronic device 2 to enter the shutdown state when the number of acquired images match the number of predetermined images.

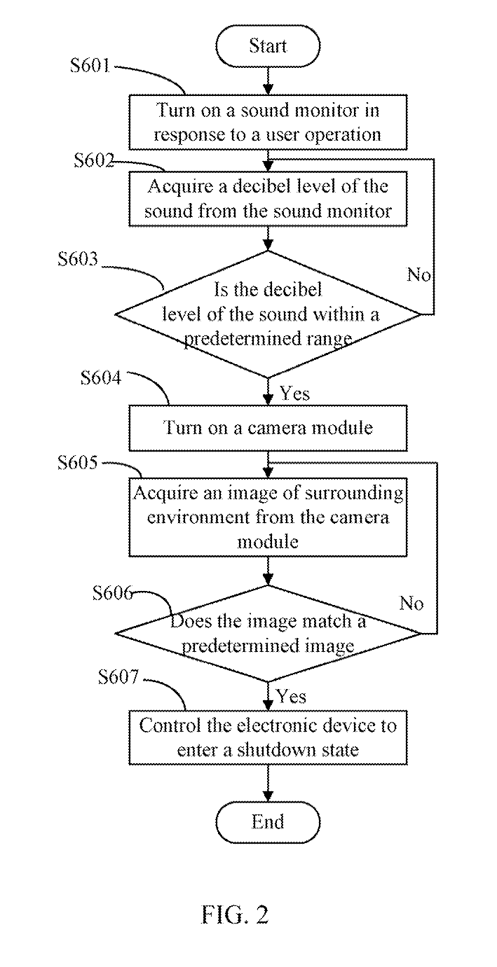

FIG. 2 is a flowchart of a power shutdown method implemented by the control system of FIG. 1.

In step S601, the switching module 235 turns on the sound monitor 21 in response to the user operation.

In step S602, the sound acquiring module 231 acquires the decibel level of the sound from the sound monitor 21.

In step S603, the first determining module 232 determines whether or not the acquired decibel level of the sound is within the predetermined range, if yes, the procedure goes to step S604, if no, the procedure goes to step S602.

In step S604, the switching module 235 turns on the camera module 22.

In step S605, the image acquiring module 236 acquires the image of the surrounding environment from the camera module 22.

In step S606, the second determining module 237 determines whether or not the acquired image of the surrounding environment matches the predetermined image, if yes, the procedure goes to step S607, if no, the procedure goes to step S605.

In step S607, the control module 234 controls the electronic device 2 to enter the shutdown state.

Although various embodiments have been specifically described, the disclosure is not to be construed as being limited thereto. Various changes or modifications may be made to the embodiments without departing from the scope and spirit of the disclosure.

What is claimed is:

1. A control system for power shutdown of an electronic device, wherein the electronic device comprises a sound monitor, the sound monitor is configured to monitor a decibel level of sound generated by surrounding environment, the control system comprising:
at least one processor; and
a plurality of modules to be executed by the at least one processor, wherein the plurality of modules comprises:
a sound acquiring module configured to acquire the decibel level of the sound from the sound monitor;
a first determining module configured to determine whether or not the acquired decibel level of the sound is within a predetermined range; and
a control module configured to control the electronic device to enter a shutdown state when the acquired decibel level of the sound is within the predetermined range.

2. The control system as described in claim 1, wherein the plurality of modules further comprises:
a switching module configured to turn on/off the sound monitor to switch the sound monitor between an enabled state and a disabled state in response to a user operation.

3. The control system as described in claim 2, wherein the switching module is further configured to turn on a camera module of the electronic device to capture an image of surrounding environment when the acquired decibel level of the sound is within the predetermined range, the plurality of modules further comprises:
an image acquiring module configured to acquire the image of the surrounding environment from the camera module;
a second determining module configured to determine whether or not the acquired image of the surrounding environment matches a predetermined image; and
the control module further configured to control the electronic device to enter the shutdown state when the acquired image of the surrounding environment matches the predetermined image.

4. An electronic device with an automatically shutdown function comprising:
a sound monitor configured to monitor a decibel level of sound generated by surrounding environment; and
a processor configured to acquire the decibel level of the sound from the sound monitor, determine whether or not the acquired decibel level of the sound is within a predetermined range, and control the electronic device to enter a shutdown state when the acquired decibel level of the sound is within the predetermined range.

5. The electronic device as described in claim 4, wherein the processor is further configured to turn on/off the sound monitor to switch the sound monitor between an enabled state and a disabled state in response to a user operation.

6. The electronic device as described in claim 5, further comprising
a camera module configured to capture an image of surrounding environment when in an enabled state;
wherein the processor is further configured to turn on the camera module when the acquired decibel level of the sound is within the predetermined range, acquire the image of the surrounding environment from the camera module, determine whether or not the acquired image of the surrounding environment matches a predetermined image, and control the electronic device to enter the shutdown state when the acquired image of the surrounding environment matches the predetermined image.

7. A method for power shutdown of an electronic device, wherein the electronic device comprises a sound monitor, the sound monitor is configured to monitor a decibel level of sound generated by surrounding environment, the method comprising:
acquiring the decibel level of the sound from the sound monitor;
determining whether or not the acquired decibel level of the sound is within a predetermined range; and
controlling the electronic device to enter a shutdown state when the acquired decibel level of the sound is within the predetermined range.

8. The method as described in claim 7, further comprising:
turning on/off the sound monitor to switch the sound monitor between an enabled state and a disabled state in response to a user operation.

9. The method as described in claim 8, further comprising:
turning on a camera module of the electronic device to capture an image of surrounding environment when the acquired decibel level of the sound is within the predetermined range;
acquiring the image of the surrounding environment from the camera module;
determining whether or not the acquired image of the surrounding environment matches a predetermined image; and
controlling the electronic device to enter the shutdown state when the acquired image of the surrounding environment matches the predetermined image.
